(19) United States
(12) Patent Application Publication
(10) Pub. No.: US 2020/0401764 A1
(43) Pub. Date: Dec. 24, 2020

(54) SYSTEMS AND METHODS FOR GENERATING ABSTRACTIVE TEXT SUMMARIZATION

(71) Applicant: BEIJING DIDI INFINITY TECHNOLOGY AND DEVELOPMENT CO., LTD., Beijing (CN)

(72) Inventors: Kun Han, Mountain View, CA (US); Haiyang Xu, Beijing (CN)

(73) Assignee: BEIJING DIDI INFINITY TECHNOLOGY AND DEVELOPMENT CO., LTD., Beijing (CN)

(21) Appl. No.: 17/014,240

(22) Filed: Sep. 8, 2020

Related U.S. Application Data
(63) Continuation of application No. PCT/CN2019/087036, filed on May 15, 2019.

(51) Int. Cl. G06F 40/211; G06N 3/04; G06F 16/93; G06N 7/00; G06F 40/284

(52) U.S. Cl. CPC G06F 40/211; G06N 3/04; G06F 40/284; G06N 7/005; G06F 16/93

(57) ABSTRACT

Embodiments of the disclosure provide systems and methods for generating text summarization. An exemplary system may include a processor and a non-transitory memory storing instructions that, when executed by the processor, cause the system to perform the various operations. The operations may include generating a document representation of a document. The document representation may include syntactic information. The operations may also include extracting salient information based on the document representation. The operations may further include generating a summary of the document based on the syntactic information and the salient information.

### CROSS-REFERENCE TO RELATED APPLICATION

This application is a continuation of International Application No. PCT/CN2019/087036, filed May 15, 2019, the entire contents of which are expressly incorporated herein by reference.

### TECHNICAL FIELD

The present disclosure relates to systems and methods for generating text summarization, and more particularly to systems and methods for generating abstractive text summarization utilizing syntactic information and dynamically selected salient information.

### BACKGROUND

Text summarization aims to automatically generate a summary consisting of main information of a source text. The summary may be in the form of a headline or a short passage. Text summarization is often performed as part of Natural Language Processing (NLP) and Information Retrieval (IR).

Existing approaches for text summarization are divided into two major types: extractive and abstractive. Extractive text summarization methods produce summaries by extracting sentences or tokens from the source text, which can produce grammatically correct summaries and preserve the meaning of the source text. However, these extractive methods rely heavily on the text in source documents and the extracted sentences may contain redundant information or have poor readability. Abstractive text summarization methods produce summaries by generating novel sentences or tokens that may not appear in the source documents. Compared to the extractive counterparts, abstractive methods are more difficult to implement because they need to address problems such as semantic representation and natural language generation.

Recent developments on neural networks have seen application of a sequence-to-sequence (Seq2Seq) technique, originally developed for machine translation, to abstractive text summarization. While achieving tremendous success in machine translation, adopting the Seq2Seq approach in text summarization faces certain obstacles due to the intrinsic differences between these two applications. Unlike machine translation, in which the objective is to capture all the semantic details from the source text, text summarization focuses on salient text information. As a result, it is difficult for a Seq2Seq-based model to generate summaries containing primarily salient information, and the generated text may also be susceptible to repetition issues. In addition, existing methods often ignore syntactic information of the source text, which may play an important role in constructing an accurate summary.

To address the above problems, there is a need for more advanced systems and methods for generating text summaries based on syntactic information and dynamically selected salient information.

### SUMMARY

In one aspect, embodiments of the disclosure provide a system for generating text summarization. The system may include at least one processor and at least one non-transitory memory storing instructions that, when executed by the processor, cause the system to perform operations. The operations may include generating a document representation of a document. The document representation may include syntactic information. The operations may also include extracting salient information based on the document representation. The operations may further include generating a summary of the document based on the syntactic information and the salient information.

In another aspect, embodiments of the disclosure provide a method for generating text summarization. The method may include generating a document representation of a document. The document representation may include syntactic information. The method may also include extracting salient information based on the document representation. The method may further include generating a summary of the document based on the syntactic information and the salient information.

In a further aspect, embodiments of the disclosure provide a non-transitory computer-readable medium having instructions stored thereon that, when executed by one or more processors, causes the one or more processors to perform operations. The operations may include generating a document representation of a document. The document representation may include syntactic information. The operations may also include extracting salient information based on the document representation. The operations may further include generating a summary of the document based on the syntactic information and the salient information.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a block diagram of an exemplary system for generating text summarization, consistent with some disclosed embodiments.

FIG. 2 illustrates an exemplary work flow for generating text summarization, consistent with some disclosed embodiments.

FIG. 3 illustrates a flowchart of an exemplary method for generating text summarization, consistent with some disclosed embodiments.

FIG. 4 illustrates an exemplary document and its target summary.

FIG. 5 illustrates an exemplary parsing tree, consistent with some disclosed embodiments.

FIG. 6 illustrates exemplary dynamic selection results, consistent with some disclosed embodiments.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Embodiments of the present disclosure provide a novel syntactic and selective encoding model for abstractive summarization (SSEMAS). The model is configured to learn syntactic and salient information from a source document for text summarization. Compared to other Seq2Seq-based methods that ignore the syntactic information, embodiments disclosed herein improve the accuracy of generated summaries and reduce or avoid issues such as word redundancy. Embodiments of the disclosure incorporate syntactic information such as parsing trees containing structured linguistic information into an encoder sequence to learn more effective sentence representation. In some embodiments, a dynamic selective encoding mechanism is adopted to control the salient information flow from the encoder to the decoder during decoding process, which improves word prediction and reduce word repetition. In some embodiments, an improved pointer-generator network having a syntactic attention layer is used to select salient words from relevant portions of the source document. The selection of salient words can be coupled with a word generation mechanism, controlled by a switch probability, to handle out-of-vocabulary (OOV) problems and to further enhance the accuracy and readability of the generated summary.

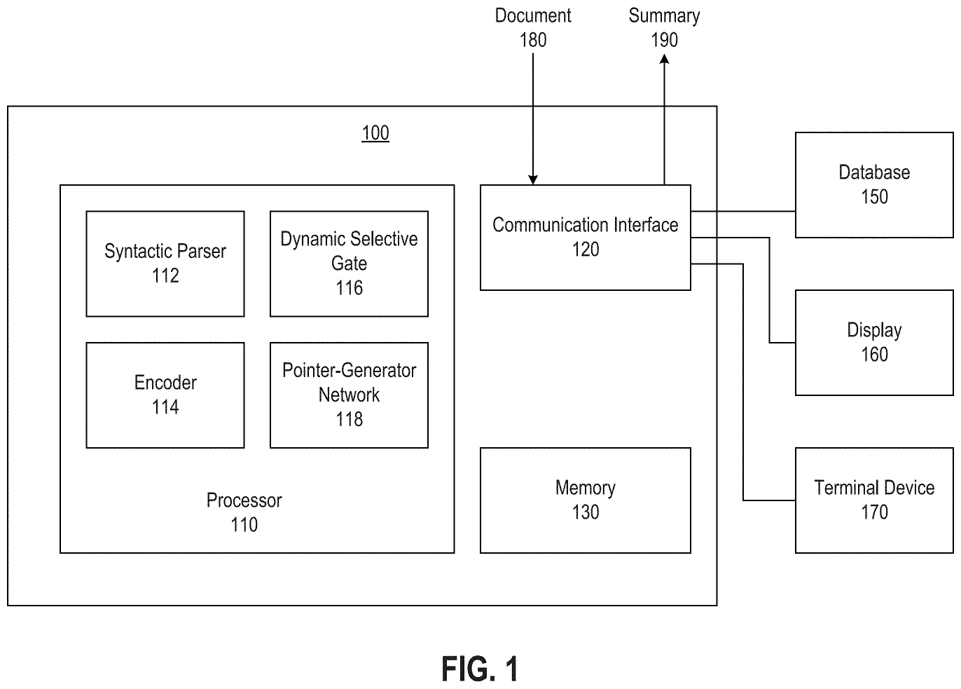

FIG. 1 illustrates a block diagram of an exemplary system 100 for generating text summarization. System 100 may include a memory 130 configured to store computer instructions that, when executed by at least one processor, can cause system 100 to perform various operations disclosed herein. Memory 130 may be any non-transitory type of mass storage, such as volatile or non-volatile, magnetic, semiconductor-based, tape-based, optical, removable, non-removable, or other type of storage device or tangible computer-readable medium including, but not limited to, a ROM, a flash memory, a dynamic RAM, and a static RAM.

System 100 may further include a processor 110 configured to perform the operations in accordance with the instructions stored in memory 130. Processor 110 may include any appropriate type of general-purpose or special-purpose microprocessor, digital signal processor, microcontroller, or the like. Processor 110 may be configured as a separate processor module dedicated to performing one or more specific operations. Alternatively, processor 110 may be configured as a shared processor module for performing other operations unrelated to the one or more specific operations disclosed herein. As shown in FIG. 1, processor 110 may include multiple modules, such as a syntactic parser 112, an encoder 114, a dynamic selective gate 116, a pointer-generator network 118, and the like. These modules (and any corresponding sub-modules or sub-units) can be hardware units (e.g., portions of an integrated circuit) of processor 110 designed for use with other components or to execute part of a program or software codes stored on memory 130. Although FIG. 1 shows modules 112-118 all within one processor 110, it is contemplated that these modules may be distributed among multiple processors located closely or remotely with each other.

System 100 may also include a communication interface 120 configured to communicate information between system 100 and other devices or systems. For example, communication interface 120 may include an integrated services digital network (ISDN) card, a cable modem, a satellite modem, or a modem to provide a data communication connection. As another example, communication interface 120 may include a local area network (LAN) card to provide a data communication connection to a compatible LAN. As a further example, communication interface 120 may include a high-speed network adapter such as a fiber optic network adaptor, 10G Ethernet adaptor, or the like. Wireless links can also be implemented by communication interface 120. In such an implementation, communication interface 120 can send and receive electrical, electromagnetic or optical signals that carry digital data streams representing various types of information via a network. The network can typically include a cellular communication network, a Wireless Local Area Network (WLAN), a Wide Area Network (WAN), or the like.

In some embodiments, communication interface 120 may communicate with a database 150 to exchange information related to text summarization. Database 150 may include any appropriate type of database, such as a computer system installed with a database management software. Database 150 may store source documents, summaries generated by system 100, training data, or any data related to text summarization.

In some embodiments, communication interface 120 may communicate with an output device, such as a display 160. Display 160 may include a display device such as a Liquid Crystal Display (LCD), a Light Emitting Diode Display (LED), a plasma display, or any other type of display, and provide a Graphical User Interface (GUI) presented on the display for user input and data depiction. For example, the content of a source document or a summary of the source document generated by system 110 may be displayed on display 160.

In some embodiments, communication interface 120 may communicate with a terminal device 170. Terminal device 170 may include any suitable device that can interact with a user. For example, terminal device 170 may include a desktop computer, a laptop computer, a smart phone, a tablet, a wearable device, or any kind of device having computational capability sufficient to support processing of text content.

Regardless of which devices or systems are coupled to communication interface 120, communication interface 120 may receive a source document 180 (also referred to as a “document”) from a first device/system and send a summary 190 to a second device/system. The first and second device/system may or may not be the same. Functionally, system 100 may be configured as a text summarization service provider that generates summary 190 based on document 180. For example, document 180 may be an article, a news report, a book chapter, or any type of text consisting of multiple text units. A text unit may be a sentence, a passage, a paragraph, or any appropriate structural division of a text document. System 100 may process document 180 and generate summary 190 containing main or important information of document 180. Summary 190 is shorter than document 180. For example, summary 190 may contain few words than document 180. The words in summary 190 may or may not be present in document 180. For example, certain words may be selected from document 180, other words may be generated from a vocabulary database based on analyzing the content of document 180.

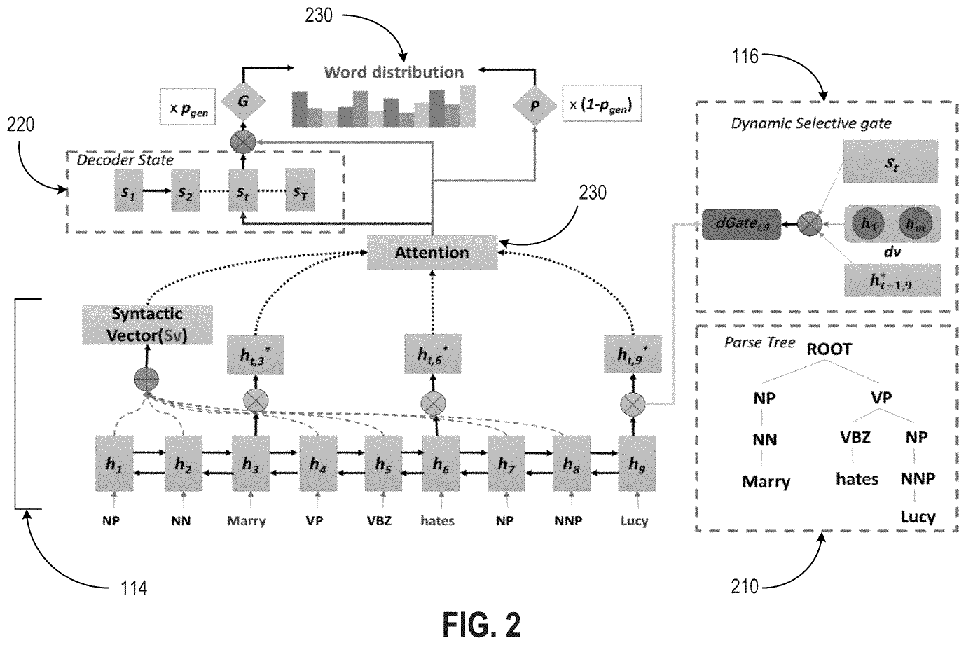

Consistent with the disclosed embodiments, processor 110 may be configured to receive document 180 through communication interface 120. After receiving document 180, processor 110 may, using one or more modules such as 112-118, process document 180 to generate summary 190, which may be stored in memory 130 and/or sent to other devices/systems such as database 150, display 160, and terminal device 170. An exemplary work flow of processing document 180 is illustrated in FIG. 2. In the following, modules 112-118 of processor 110 will be described in connection with the work flow shown in FIG. 2.

Processor 110 may obtain syntactic information from document 180. In some embodiments, syntactic parser 112 may be configured to generate a parsing tree for each sentence in document 180. Each parsing tree can be serialized as a sequence. Sequences of the sentences may be concatenated and fed into a unified neural network encoder, such as encoder 114, to generate a document representation. In this way, the document representation can capture not only the semantic information of the sentences, but also the syntactic information (e.g., linguistic structure information) from corresponding parsing trees.

Specifically, assume that document 180 (d) can be denoted as a sequence of text units such as sentences (s): d=<s₁, s₂, . . . , sₙ>, where n is the number of sentences in document 180, then for each sentence sᵢ, syntactic parser 112 can be applied to generate a parsing tree lᵢ. An exemplary parsing tree 210 is shown in FIG. 2. Each parsing tree can be serialized using, for example, a depth-first traversal method, into a sequence of tokens: lᵢ=<e_{i,1}, e_{i,2}, . . . , e_{i,k}_{ᵢ}>, where kᵢ is the number of tokens in the ith serialized parsing tree. Note that the token et, is not necessarily a word. For example, referring to FIG. 2, parsing tree 210 contains leaf nodes (e.g., “Marry,” “hates,” and “Lucy”) and non-leaf nodes (e.g., “NP,” “NN,” etc.). A leaf note may represent a word, while a non-leaf node may represent a syntactic label including, for example, a phrase label, a part-of-speech (POS) tag, etc. For instance, “NP” means “Noun phrase,” “VP” means “Verb phrase,” “NN” means “Noun, singular or mass,” “VBZ” means “Verb, 3^{rd} person singular present,” etc.

The serialized sequences of tokens may be concatenated into a long sequence d=<e₁, e₂, . . . , eₘ>, where m is the total number of tokens from all parsing trees m=Σᵢkᵢ. Encoder 114 may then be applied to the concatenated sequences of tokens to generate the document representation. For example, a bidirectional long short-term memory (BiLSTM) may be implemented as encoder 114. The BiLSTM may include a forward LSTM \vec{f}, which reads document sequence d from e₁ to eₘ. In addition, the BiLSTM may also include a backward LSTM [symbol] , which reads document sequence d from eₘ to e₁, according to the following equations:

xⱼ=Wₑeⱼ,j∈{1, . . . ,m} (1)

\vec{h}ⱼ=\vec{LSTM}(xⱼ,\vec{h}ⱼ₋₁),j∈{1, . . . ,m} (2)

[symbol]

ⱼ= [symbol] (xⱼ, [symbol] ⱼ₊₁),j∈{1, . . . ,m} (3)

where xⱼ is the distributed representation of token eⱼ by embedding matrix Wₑ, which is shared by both words and syntactic labels. A source word representation hⱼ can be obtained by concatenating forward hidden state \vec{h}ⱼ with backward hidden state [symbol] ⱼ: hⱼ=[\vec{h}ⱼ, [symbol] ⱼ]. The last forward hidden state \vec{h}ₘ and the first backward hidden state [symbol] ₁ can be concatenated to obtain the document representation dv=[\vec{h}ₘ, [symbol] ₁].

As shown in FIG. 2, encoder 114 may pass annotation vectors of words (e.g., “Mary”—h₃, “hates”—h₆, “Lucy”—h₉) to a decoder. Encoder 114 may also concatenate annotation vectors of syntactic labels (e.g., “NP”—h₁, “VP”—h₄, “NNP”—h₈, etc.) as a syntactic vector sᵥ by, for example, maxpooling. Syntactic vector s may be fed into pointer-generator network 118 to select salient information of source document 180.

Unlike machine translation, in which generation of output needs to keep all information of input in every decoding time step, in abstractive summarization it is more important to keep the salient information and remove inessential information of the input to improve efficiency. Embodiments of the disclosure provide a novel dynamic selective mechanism to model the dynamic generation process of the target words in summary 190. For example, dynamic selective gate 116 may be configured to extract salient information and keep the salient information flow from encoder 114 to every state of decoder 220. Parameters of dynamic selective gate 116 may be determined based on document 180 and the current decoding state, considering that the salient information for current decoding step t should be relevant to the source document 180 and currently generated words. In addition, to address the repetition issue common to traditional Seq2Seq framework methods, parameters of dynamic selective gate 116 may be determined based on text already generated in summary 190, thereby taking into account the decisions made in previous decoding steps. In this way, selecting of the same information may be avoided, preventing the generation of repetitive words.

In some embodiments, for every word in each decoding time step t, dynamic selective gate dGate_{t,j} can be calculated from document representation dv, current decoder state sₜ, and previously selected encoder word state h*_{t-1,j}. After applying dynamic selective gate dGateₜ, document sequence word vectors H*ₜ={h*_{t,1}, h*_{t,2}, . . . , h*_{t,m}} at current decoding time step t can be obtained according to the following equations:

dGate_{1,j}=σ(W_{S}dv+U_{S}sₜ+V_{S}hⱼ+bₛ) (4)

dGate_{t,j}=σ(Wₛdv+Uₛsₜ+Vₛh*_{t-1,j}+bₛ) (5)

h*_{t,j}=dGate_{t,j}⊙hⱼ (6)

where vector Wₛ, Uₛ, Vₛ, and bₛ are learnable parameters, σ is the sigmoid function, hⱼ is the jth token hidden state of the BiLSTM encoder, and ⊙ is element-wise multiplication. Document sequence word vectors H*ₜ may contain salient information extracted by dynamic selective gate 116. H*ₜ may be fed into an attention layer 230 (shown in FIG. 2) to generate target words to form summary 190.

The salient information of document 180, such as key words and name entities, are often unavailable in a vocabulary database used for generating abstractive summaries. To handle such OOV problems, pointer-generator network 118 may be used, which allows both selecting (e.g., copying) words from source document 180 via “pointing” and “generating” new words from the vocabulary database. Embodiments of the present disclosure combine the pointer-generator technique with syntactic attention (e.g., via attention layer 230) that copies salient words in semantic and syntactic aspects to generate accurate summarization of document 180.

In some embodiments, at each decoding time step t, word embedding of previously generated word wₜ₋₁ and a previous context vector cₜ₋₁ may be used to compute the new decoder state sₜ. A syntactic attention distribution aₜ={a_{t,1}, a_{t,2}, . . . , a_{t,m}} can be calculated base on the current decoder state sₜ, the currently selected encoder hidden state H*ₜ, and document structural vectors sv. The syntactic attention represents the importance score of the currently selected encoder hidden state H*ₜ and is normalized to obtain the current context vector cₜ by weighted sum, as follows:

$$\begin{matrix}{s}_{t} = L S T M ( {w}_{t - 1} , {c}_{t - 1} , {s}_{t - 1} ) & ( 7 ) \\ {e}_{t , j} = {v}^{T} tanh ( {W}_{a} {h}_{t , j}^{*} + {U}_{a} s v + {V}_{a} {s}_{t} + {b}_{a} ) & ( 8 ) \\ {a}_{t} = s o f t m a x ( {e}_{t} ) & ( 9 ) \\ {c}_{t} = {\sum }_{i = 1}^{n} {\sum }_{j = 1}^{m} {a}_{t , j} {h}_{t , j}^{*} & ( 10 )\end{matrix}$$

where Wₐ, Uₐ, Vₐ, and bₐ are learnable parameters.

Context vector cₜ and current decoder state sₜ may be concatenated to pass two linear layers and predict the next word with a softmax layer:

P_{vocab}=softmax(Vᵥ(Wᵥ[cₜ,sₜ]+b_{w})+bᵥ) (11)

Pointer-generator network 118 may determine a switch probability P_{gen} for decoding time step t based on context vector cₜ, decoder state sₜ, and decoder word xₜ.

P_{gen}=σ(W_{g}^{t}cₜ+U_{g}^{t}sₜ+V_{g}^{t}xₜ+b_{g}) (12)

Based on the switch probability P_{gen}, pointer-generator network 118 may determine whether to generate a word according to P_{vocab} from the vocabulary database or to select/copy a word from document 180 by the current syntactic attention aₜ. The word probability distribution P(w) over the source document 180 and the vocabulary database is:

$$P ( w ) = {P}_{g e n} {P}_{v o c a b} ( w ) + ( 1 - {P}_{g e n} ) {\sum }_{i = 1}^{n} {\sum }_{j = 1}^{m} {a}_{t , j} \qquad ( 13 )$$

where W_{g}^{t}, U_{g}^{t}, V_{g}^{t}, and scalar b_{g} are learnable parameters and σ is the sigmoid function. Based on the word probability distribution (illustrated as 230 in FIG. 2), pointer-generator network 118 may determine a word of summary 190 by either selecting the word from document 180 or generating the word based on the vocabulary database.

In some embodiments, learnable parameters, such as Wₛ, Uₛ, Vₛ, bₛ, Wₐ, Uₐ, Vₐ, bₐ, W_{g}^{t}, U_{g}^{t}, V_{g}^{t}, and b_{g}, can be trained using a training dataset. For example, a loss function may be defined to maximize the output summary probability given an input document (e.g., document 180). In some embodiments, the loss function can be defined as a negative log-likelihood loss function:

$$l o s s = - \frac{1}{\vert D \vert} {\sum }_{( d , y ) ∈ D} log p ( y \vert d ) \qquad ( 14 )$$

where D represents all documents in the training dataset, d is a document having a concatenated sentence sequence d={e₁, e₂, . . . , eₘ}, y is the corresponding reference summary (e.g., provided as the target result). In some embodiments, to handle the repetition problem, a coverage mechanism is used, which adds a coverage vector cvₜ=Σ_{t′=0}^{t-1}a_{t′} to the attention layer 230. Accordingly, a coverage loss penalizing repeated selection of identical encoder information may be added to the loss function:

$$l o s s = - \frac{1}{\vert D \vert} {\sum }_{( d , y ) ∈ D} ( logp ( y \vert d ) + λ {\sum }_{t} min ( {a}_{t , i} , {cv}_{t , i} ) ) \qquad ( 15 )$$

Loss function defined in equation (15) may be minimized in the model training process.

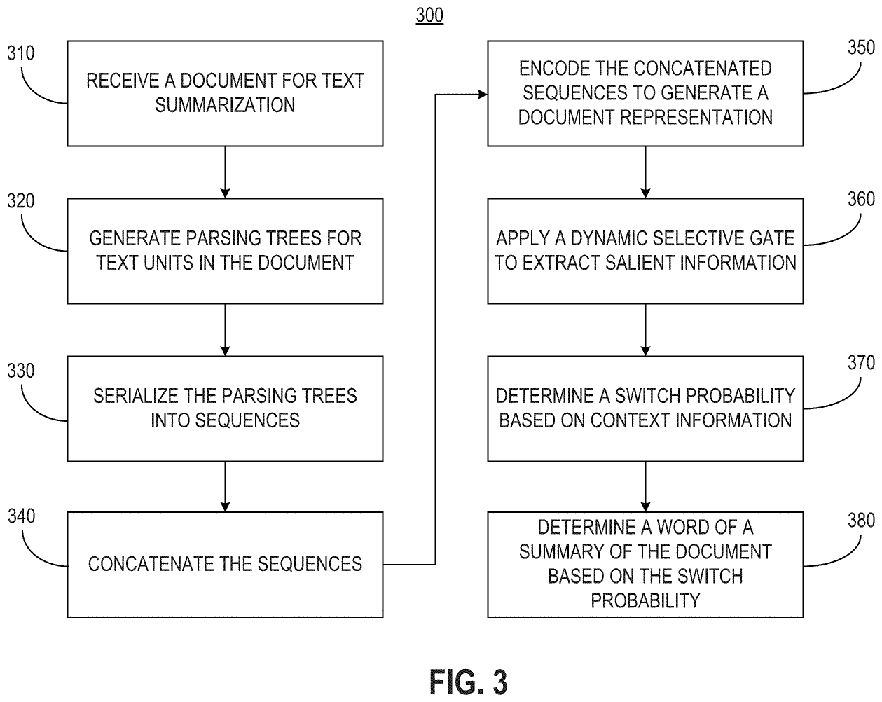

FIG. 3 illustrates a flowchart of an exemplary method 300 for generating text summarization based on syntactic and salient information. In some embodiments, method 300 may be implemented by system 100 that includes, among other things, memory 120 and processor 110 that performs various operations using one or more modules 112-118. It is to be appreciated that some of the steps may be optional to perform the disclosure provided herein, and that some steps may be inserted in the flowchart of method 300 that are consistent with other embodiments according to the current disclosure. Further, some of the steps may be performed simultaneously, or in an order different from that shown in FIG. 3.

In step 310, processor 110 of system 100 may receive a document, such as document 180, for text summarization. For example, processor 110 may receive document 180 through communication interface 120.

In step 320, processor 110 may, using syntactic parser 112, generate parsing trees (e.g., parsing tree 210 shown in FIG. 2) for text units (e.g., sentences) in document 180. Each parsing tree may contain words as well as syntactic information, such as structural labels indicating the linguistic structure of the corresponding sentence.

In step 330, processor 110 may serialize the parsing trees into sequences of tokens (e.g., lᵢ=<e_{i,1}, e_{i,2}, . . . , e_{i,k}_{ᵢ}>). For example, a depth-first traversal method may be used to serialize the parsing trees.

In step 340, processor 110 may concatenate the sequences into a long sequence (e.g., d=<e₁, e₂, . . . , eₘ>) that includes both words and syntactic labels of all the sentences in the document.

In step 350, processor 110 may encode the concatenated sequences to generate a document representation. For example, encoder 114 may be applied to the concatenated sequences of tokens to generate the document representation. In some embodiments, a BiLSTM may be implemented as the encoder that includes a forward LSTM \vec{f} and a backward LSTM [symbol] . According to equations (1)-(3), the document representation dv=[\vec{h}ₘ, [symbol] ₁] can be generated.

In step 360, processor 110 may apply dynamic selective gate 116 to extract salient information from document 180 to handle the OOV problem. Parameters of dynamic selective gate 116 may be determined based on document 180 and the current decoding state. In addition, to address the repetition issue common to traditional Seq2Seq framework methods, parameters of dynamic selective gate 116 may be determined based on text already generated in summary 190, thereby taking into account the decisions made in previous decoding steps. For example, parameters of dynamic selective gate 116 may be determined according to equations (4)-(5). Application of dynamic selective gate 116 can be implemented according to equation (6). Document sequence word vectors H*ₜ may be obtained after applying dynamic selective gate 116. H*ₜ may contain salient information extracted by dynamic selective gate 116.

In step 370, processor 110 may, using pointer-generator network 118, determine a switch probability P_{gen} (e.g., according to equation (12)). Switch probability P_{gen} may be used to determine whether to generate a word from the vocabulary database or to select/copy a word from document 180.

In step 380, processor 110 may, using pointer-generator network 118, determine a word of summary 190 based on the switch probability P_{gen}. For example, word probability distribution P(w) may be determined based on equation (13). Based on the word probability distribution, pointer-generator network 118 may determine a word of summary 190 by either selecting the word from document 180 or generating the word based on the vocabulary database.

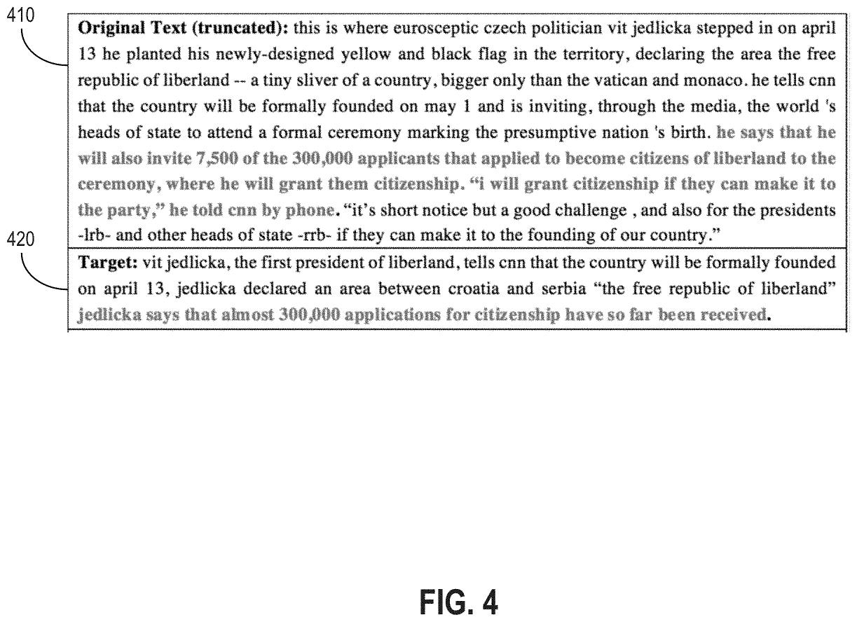

FIG. 4 illustrate a sample text 410 (e.g., a form of document 180) and a target summary 420 (e.g., provided as part of a training dataset to serve as the reference for training). During the training process, text 410 may be used as an input to system 100. The output of system 100 may be compared against target summary 420 to adjust one or more learnable parameters.

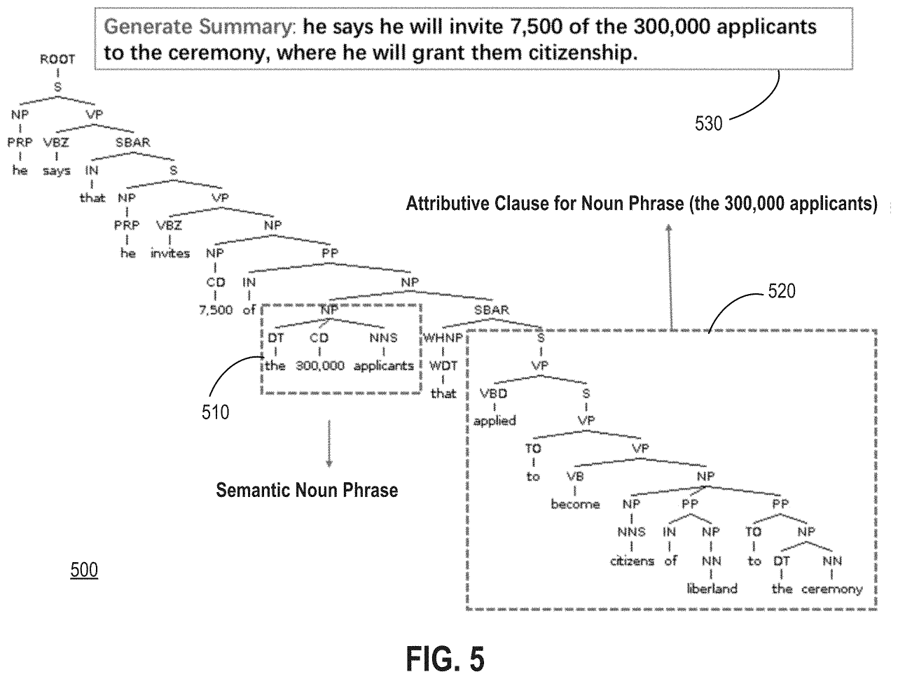

FIG. 5 illustrates an exemplary parsing tree 500. As shown in FIG. 5, parsing tree 500 may include words as the leaf notes, as well as syntactic labels on the non-leaf notes. For example, parsing tree 500 contains sentence structural information: branches 510 indicate that “the 300,000 applicants” is a noun phrase; branches 520 indicate 510 that “applied to . . . ceremony” is an attributive clause of the noun phrase “the 300,000 applicants.” Based on the syntactic information, processor 110 can generate a summary 530 that substantially matches the target summary 420.

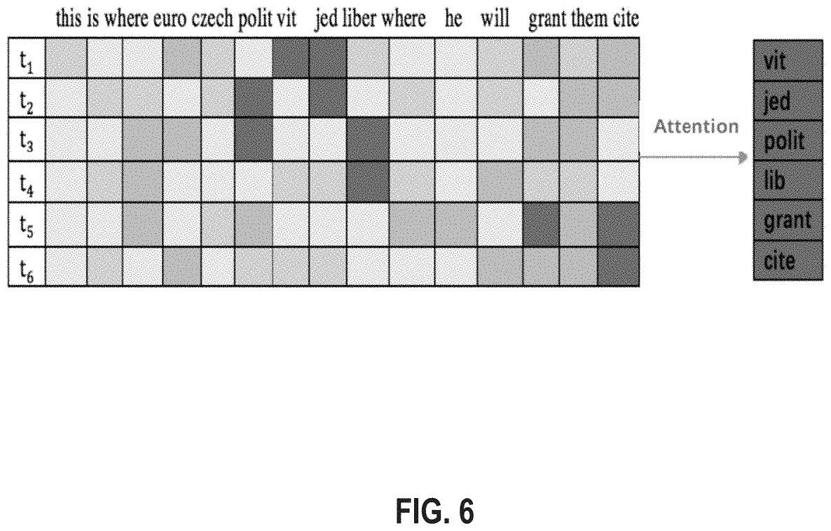

FIG. 6, illustrates exemplary dynamic selection results after applying dynamic selective gate 116. As shown in FIG. 6, the weight of each candidate word is indicated by the corresponding gray scale, with darker shades indicating heavier weights. FIG. 6 shows that dynamic selective gate 116 can select the most important information from text 410 in every decoding step (t₁ . . . t₆). For example, at decoding step t₁, dynamic selective gate 116 filters out nonessential words such as “the,” “is,” and “he,” and selects the salient words (e.g., “vit” “jedlicka”) to help the attention layer (e.g., 230) to generate the most important word (e.g., “vit”). Moreover, words that are not present in the vocabulary database (e.g., “vit” “jedlicka”) can be selected from source text 410 to copied to the generated summary. Further, the weight of the words already selected in previous steps (e.g., “vit” in time step t₁) are decreased in the following time steps (e.g., in time step t₂ the weight of “vit” is significantly decreased). Therefore, the word repetition problem can be alleviated or even avoided.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor-based, tape-based, optical, removable, non-removable, or other types of computer-readable medium or computer-readable storage devices. For example, the computer-readable medium may be the storage device or the memory module having the computer instructions stored thereon, as disclosed. The computer-readable medium may be a disc, a flash drive, or a solid-state drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A system for generating text summarization, comprising:
at least one processor; and
at least one non-transitory memory storing instructions that, when executed by the at least one processor, cause the system to perform operations comprising:
generating a document representation of a document, the document representation comprising syntactic information;
extracting salient information based on the document representation; and
generating a summary of the document based on the syntactic information and the salient information.

2. The system of claim 1, wherein the operations comprise:
generating, by a syntactic parser, parsing trees for multiple text units in the document, the parsing trees comprising structural labels of the text units.

3. The system of claim 2, wherein the operations comprise:
serializing each parsing tree into a sequence of tokens; and
concatenating the sequences of tokens.

4. The system of claim 3, wherein the operations comprise:
applying an encoder to the concatenated sequences of tokens to generate the document representation.

5. The system of claim 4, wherein the encoder comprises a bidirectional long short-term memory (BiLSTM).

6. The system of claim 1, wherein the operations comprise:
applying a dynamic selective gate to the document representation to extract the salient information.

7. The system of claim 6, wherein the operations comprise:
determining the dynamic selective gate based on text already generated in the summary.

8. The system of claim 1, wherein the operations comprise:
determining, by a pointer-generator network, a switch probability based on context information; and
determining, based on the switch probability, a word of the summary by selecting the word from the document or generating the word based on a vocabulary database.

9. The system of claim 8, wherein the operations comprise:
determining, by the pointer-generator network, the context information based on the syntactic information.

10. The system of claim 1, wherein the operations comprise:
minimizing a loss function comprising a coverage loss penalizing repeated selection of identical encoder information.

11. A method for generating text summarization, comprising:
generating a document representation of a document, the document representation comprising syntactic information;
extracting salient information based on the document representation; and
generating a summary of the document based on the syntactic information and the salient information.

12. The method of claim 11, comprising:
generating, by a syntactic parser, parsing trees for multiple text units in the document, the parsing trees comprising structural labels of the text units.

13. The method of claim 12, comprising:
serializing each parsing tree into a sequence of tokens; and
concatenating the sequences of tokens

14. The method of claim 13, comprising:
applying an encoder to the concatenated sequences of tokens to generate the document representation.

15. The method of claim 11, comprising:
applying a dynamic selective gate to the document representation to extract the salient information.

16. The method of claim 15, comprising:
determining the dynamic selective gate based on text already generated in the summary.

17. The method of claim 11, comprising:
determining, by a pointer-generator network, a switch probability based on context information; and
determining, based on the switch probability, a word of the summary by selecting the word from the document or generating the word based on a vocabulary database.

18. The method of claim 17, comprising:
determining, by the pointer-generator network, the context information based on the syntactic information.

19. The method of claim 11, comprising:
minimizing a loss function comprising a coverage loss penalizing repeated selection of identical encoder information.

20. A non-transitory computer-readable medium having instructions stored thereon that, when executed by one or more processors, causes the one or more processors to perform a method for generating text summarization, the method comprising:
generating a document representation of a document, the document representation comprising syntactic information;
extracting salient information based on the document representation; and
generating a summary of the document based on the syntactic information and the salient information.
